(19) United States
(12) Patent Application Publication
(10) Pub. No.: US 2006/0125364 A1
(43) Pub. Date: Jun. 15, 2006

(54) Image display apparatus

(76) Inventors: Hikaru Takeda, Tokyo (JP); Tatsuya Masuda, Sagamihara (JP)

Correspondence Address: 3M INNOVATIVE PROPERTIES COMPANY, PO BOX 33427, ST. PAUL, MN, 55133-3427, US

(21) Appl. No.: 10/520,752

(22) PCT Filed: Jun. 24, 2003
(86) PCT No.: PCT/US03/19974

§ 371 Date: Jan. 10, 2005

(30) Foreign Application Priority Data
Aug. 1, 2002 (JP) 2002-224995

(51) Int. Cl. H01J 17/49

(52) U.S. Cl. 313/46; 313/582

(57) ABSTRACT

To provide an image display apparatus that is simple in construction, makes it easy to conduct repairing of components, disposal, recycling, etc, eliminates remains of adhesives on the component and can be produced at a low cost of production. A thermally conductive sheet is sandwiched between an image display panel and a supporting plate, and at least one adhesive tape having sufficient bonding strength for holding the display panel and capable of being peeled from the supporting plate when pulled at its end portion is bonded to a surface of the supporting plate that is not occupied by the thermally conductive sheet.

### TECHNICAL FIELD

This invention relates to an image display apparatus, more particularly, this invention relates to an image display apparatus having a flat panel construction in which a fixing method of a display panel is improved. The invention specifically relates to a plasma display apparatus.

### BACKGROUND

It is well known that image display apparatuses using a cathode ray tube (CRT) have been economically mass-produced owing to progress and development of television technologies achieved so far. In recent years, however, flat panel displays having smaller thickness and smaller weight have drawn an increasing attention as an image display apparatus of the next generation to replace the CRT image display apparatus.

One of typical flat display panels is a liquid crystal display (LCD), and it has already been used as a compact display apparatus for notebook type personal computers, cellular telephones, personal digital assistants (PDA) and other mobile information terminals. On the other hand, a plasma display panel (PDP) is a typical example of flat panel displays having a small thickness and a large display screen. It has practically been used for business applications, and recently as a wall-hung television for home use.

A PDP 50 illustrated in FIG. 1 for reference has only one discharge display cell 56 to simplify illustration, but generally includes a large number of minute discharge display cells. Each discharge display cell 56 is defined by a pair of glass substrate separated from, and opposing, each other, that is, front surface glass substrate 61 and a back surface glass substrate 51 and ribs 54 having a minute structure and arranged in a predetermined shape between these glass substrates. The front surface glass substrate 61 has thereon a transparent display electrode 63 consisting of a scanning electrode and a holding electrode, a transparent dielectric layer 62 and a transparent protective layer 64. The back surface glass substrate 51 has thereon an address electrode 53 and a dielectric layer 52. Each display electrode 63 having the scanning electrode and the holding electrode crosses each address electrode 53 and is arranged in a predetermined pattern with a gap. Each discharge display cell 56 has a phosphor layer 55 on its inner wall, and a rare gas (such as Ne—Xe gas) is sealed into the cell 56 so that spontaneous light emission display can be made upon plasma discharge occurring between the electrodes.

Generally, the PDP is fitted to an aluminum frame for use. Because it uses the glass substrates, the PDP has a considerable weight (generally, about 8 to 10 kg). To prevent the PDP from easily peeling or falling, it has been customary to employ a method that bonds the PDP to the frame by use of a strong double-face adhesive tape, or fixes the PDP at a plurality of positions by use of set-screws. Furthermore, heat generation occurs to a considerable extent during the operation of the PDP due to plasma discharge, and the temperature generally reaches about 80 to 90° C. Therefore, it has also been customary to sandwich a thermally conductive sheet or a thermally conductive adhesive sheet between the frame and the PDP to improve a heat radiation effect.

Japanese Unexamined Patent Publication (Kokai) No. 2001-11402, for example, discloses a plasma display apparatus typically shown in FIG. 2. This plasma display apparatus comprises a PDP 71, a heat radiation plate 72 and a heat radiation adhesive sheet 73 sandwiched therebetween. The adhesive heat 73 consists of a heat-dissipating adhesive composition containing an adhesive and a thermal conductivity-imparting agent. A large number of ridges 74 are formed on the surface of the adhesive sheet 73 to insure a smooth bonding operation and to prevent air entrapment. However, when the heat-dissipating adhesive sheet is bonded to the entire surface of the PDP in such a manner as not to be capable of being peeled, several problems generate. When any defect occurs during the production process, for example, it is not possible to remove the heat radiation plate (frame chassis) from the defective panel and to use it again. When any fault or breakage occurs in the PDP during its operation, it is not possible, either, to remove only the PDP and to repair or exchange it by a new PDP. Furthermore, when the PDP reaches the stage of disposal or recycling, the PDP and the heat radiation plate cannot be separated satisfactorily because the bonding strength between them is strong, and this renders the problem for smooth disposal and recycling. Even if the PDP and the heat radiation plate can be separated, remains of the adhesive unavoidably occur in these components.

To avoid the problem described above during bonding of the PDP and the frame chassis by use of the adhesive sheet, Japanese Unexamined Patent Publication (Kokai) No. 10-319863 discloses a plasma display apparatus shown in FIG. 3. The plasma display apparatus 80 comprises a case 82 having a front case 84 and a back case 86, and an inner unit 83. The front case 84 is equipped with a shading portion 81b made of glass. The internal unit 83 has an aluminum frame chassis 89, a PDP 87 and a thermally conductive sheet 88 made of silicone. Since this plasma display apparatus 80 employs the construction in which screws 92 are fitted into a plurality of fixing bosses 91 fitted to the back surface of the PDP 87, the PDP 87 can be removably fixed to the chassis 89. When the PDP is fixed by use of such set-screws, however, the construction becomes complicated, the number of components required for assembling increases and the production cost unavoidably rises. Since the screw fixing operation is troublesome, too, a method capable of removably fixing the PDP more easily is desired.

### SUMMARY

It is an object of the invention to provide an improved panel fixing method that makes it possible to use an adhesive tape having sufficient bonding strength for holding a panel and capable of being easily peeled for removing the panel when a flat display panel is fitted to a frame in a plasma display apparatus and other image display apparatuses, and can satisfy both the advantage of the use of conventional adhesive tapes and the advantage of the use of set-screws.

It is another object of the invention to provide an image display apparatus that is simple in construction, makes it easy to conduct repairing of components, disposal, recycling, etc, eliminates remains of adhesives and moreover can be produced at a low cost of production.

It is still another object of the invention to provide a plasma display apparatus in which a panel can be easily fixed to a frame and can also be separated easily from the frame.

These and other objects of the invention will be readily understood from the following detailed description of the invention.

### BRIEF DESCRIPTION OF THE DRAWINGS

FIG. 1 is a sectional view showing a general construction of the prior art PDP.

FIG. 2 is a perspective view showing an example of the prior art plasma display apparatus.

FIG. 3 is an exploded perspective view showing another example of the prior art plasma display apparatus.

FIG. 4 is an exploded perspective view showing a plasma display apparatus according to one preferred embodiment of the invention.

FIG. 5 is a front view showing an example of an adhesive tape peeling method in the plasma display apparatus according to the invention.

FIG. 6 is a front view showing another example of the adhesive tape peeling method in the plasma display apparatus according to the invention.

FIG. 7 is a front view showing one preferred example of a PDP fixing method in the plasma display apparatus according to the invention.

FIG. 8 is a front view showing another preferred example of the PDP fixing method in the plasma display apparatus according to the invention.

FIG. 9 is a front view showing still another preferred example of the PDP fixing method in the plasma display apparatus according to the invention.

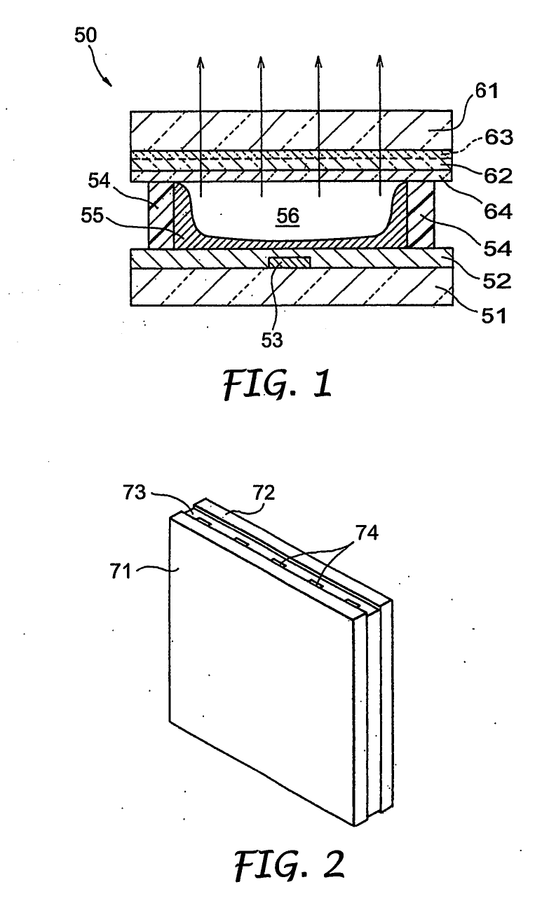

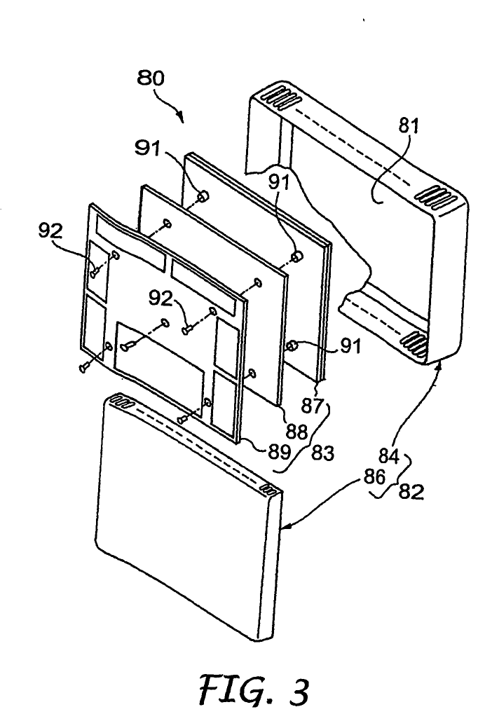

### DETAILED DESCRIPTION OF THE INVENTION

The objects described above can be accomplished by an image display apparatus comprising an image display panel and a supporting plate to which a back surface of the image display panel is removably fitted, wherein a thermally conductive sheet is sandwiched between the image display panel and the supporting plate, and at least one adhesive tape having sufficient bonding strength for holding the panel during use of the image display apparatus and capable of being peeled from the plate when pulled at an end portion thereof is bonded to a surface of the supporting plate not occupied by the thermally conductive sheet.

This invention relates to an image display apparatus comprising an image display panel and a supporting plate attached to a back surface of the image display panel and capable of being removed, whenever necessary. The image display panel to which the invention can be applied is flat display panels that have drawn an increasing attention in recent years, and typical examples include an LCD panel, a PDP panel and an organic EL panel, though they are not restrictive. The invention is particularly useful for the PDP panel because large quantities of heat are generated due to plasma discharge during the operation of the PDP panel. Therefore, the image display apparatus of the invention includes a liquid display apparatus, a plasma display apparatus, an organic EL display apparatus and others.

The image display panel is generally rectangular and is commercially available in various sizes. In the case of the PDP, for example, its size is relatively large and is generally about 700 mm (width)×about 400 mm (height) to about 1,200 mm (width)×about 700 mm (height). The image display panel generally has a thickness of about 4 to 10 mm.

In the image display apparatus of the invention, the supporting plate can be formed of various materials into various shapes. Generally, the supporting plate preferably has the function of a heat radiation plate besides the function as the support of the image display panel because remarkable heat generation occurs in most cases in the image display panel. Since the image display panel generally has a heavy weight of from about 6 to 10 kg, the supporting plate must also have strength capable of bearing the weight for a long term.

The supporting plate preferably has the function of the heat radiation plate as described above. Therefore, the plate itself is preferably formed of a material having high heat dissipation property or high thermal conductivity. Suitable examples of the heat-dissipating material include metals such as aluminum, iron, magnesium and their alloys. Note, it is preferred to use a material that is as light in weight as possible so as to reduce the weight of the apparatus.

The shape and size of the supporting plate are generally determined in accordance with the image display panel to be supported by the supporting plate. To improve the heat radiation effect, heat radiation fins or vent holes may be formed at a part of the supporting plate.

In the image display panel according to the invention, a thermally conductive sheet is sandwiched between the image display panel and the supporting plate. The thermally conductive sheet particularly transfers large quantities of heat generated during the operation of the image display panel to the supporting plates and radiates heat outside the apparatus through the supporting plate. The thermally conductive sheet can be formed of various thermally conductive materials per se having heat radiation properties. To efficiently transfer heat, therefore, the thermally conductive sheet preferably keeps close contact with the image display panel and with the support plate. Incidentally, when the thermally conductive sheet has by itself high adhesion strength, the panel cannot be smoothly removed from the supporting plate or remains of the adhesive may be left. For this reason, the thermally conductive sheet preferably has adherence property with the panel and with the supporting plate but does not have tackiness. Alternatively, the thermally conductive sheet preferably has low tackiness capable of provisionally fixing the panel even when it has tackiness. In other words, the thermally conductive sheet has removing property. Here, the term “removing property” means the property such that the thermally conductive sheet can be easily peeled off by hand at around room temperature (20 to 30° C.) without using any specific device when the panel is removed from the supporting plate. More concretely, the peel strength of the thermally conductive sheet is preferably 1 N/cm or less at room temperature.

To fully exploit its heat transfer effect and its heat radiation effect, the thermally conductive sheet is preferably sandwiched between the image display panel and the supporting plate in such a fashion that it occupies a maximum area between them. Generally, the thermally conductive sheet is preferably arranged in such a fashion as to occupy at least about 80 to 90% of the substantial portion of the back surface of the image display panel or the surface of the supporting plate. The thermally conductive sheet is further preferably arranged in such a fashion as to leave the peripheral portion of the panel or the supporting plate unoccupied by the thermally conductive sheet. If necessary, however, a large number of stripe-like thermally conductive sheets may regularly be arranged with predetermined gaps among them in place of the thermally conductive sheet described above that is arranged at the central portion. The arrangement direction of the stripe-like sheets may be a longitudinal direction or a transverse direction.

The thickness of the thermally conductive sheet may vary depending on the kind, size and the like of the image display panel. Generally, however, the thermally conductive sheet preferably has a thickness within the range of 0.5 to 3.0 mm. When the sheet thickness is below 0.5 mm, air is likely to be entrapped between the image display panel and the supporting plate and eventually, a sufficient heat transfer effect cannot be acquired. When the sheet thickness exceeds 3.0 mm, on the contrary, the thermal resistance of the thermally conductive sheet becomes great with the result that the heat transfer effect is spoiled.

The thermally conductive sheet used for the embodiment of the invention is not particularly limited so long as it is not tacky or slightly tacky, can exhibit thermal transfer property of a desired level and has hardness sufficient to improve handling property.

The thermally conductive sheet useful in the invention is a thermally conductive sheet which comprises a polymer derived from an acrylic monomer having an ether bond in the molecules thereof, that is, an acrylic monomer (acrylate) or a methacrylic monomer (methacrylate), and thermally conductive particles dispersed in the polymer, as described, for example, in Japanese Unexamined Patent Publication (Kokai) No. 11-292998.

In the image display apparatus according to the invention, at least one adhesive tape is bonded to the surface of the supporting plate that is not occupied by the thermally conductive sheet (or the back surface of the image display panel). This adhesive exhibits sufficient bonding strength to hold the panel during use of the image display apparatus, prevents accidental fall of the panel during use, can be peeled or removed from the plate when its end portion is pulled, whenever necessary, and can therefore separate the plate from the supporting plate without leaving remains of the adhesive.

The adhesive tape used herein is preferably a double-face adhesive that normally exhibits high bonding strength but can be easily peeled or removed when its end portion is pulled or in other words, a so-called “stretch release tape”.

The adhesive tape useful in the practice of the invention includes the following adhesive tape, for example.

The tape includes a substrate that is highly extensible and has a substantially non-recovering property, and a layer of a pressure-sensitive adhesive supported on both surfaces of the substrate. This tape can be strongly bonded to the supporting plate and can be removed from the supporting plate when it is stretched from the surface of the supporting plate at an angle of about 35 degrees or less, and the substrate has sufficiently high bursting point tensile strength such that the substrate is not be broken prior to the removal of the tape from the surface of the supporting plate.

In this adhesive tape, the substrate preferably has a Young's modulus of at least 17 MPa and less than about 500 MPa. The substrate preferably has elastic recovery property of about less than 50% after stretching. Further preferably, the substrate has bursting point elongation of at least about 150% in the longitudinal direction. The substrate is preferably formed of a material selected from the group consisting of polyolefin, vinyl copolymers, olefin copolymers, acryl polymers, acryl copolymers and their combination.

In this adhesive tape, the pressure-sensitive adhesive preferably has a bonding strength value of from about 0.3 to about 20 N/cm at a peel angle of 180° and at a peeling rate of 12.7 cm/min.

Note that the detail of this adhesive tape is disclosed in Japanese Unexamined Patent Publication (Kokai) No. 6-504077, for example.

In the practice of the invention, the following adhesive tapes may also be used advantageously.

(1) An adhesive tape comprising a substrate and layers of a pressure-sensitive adhesive applied to both surfaces of the substrate, wherein the substrate includes a polymer foam layer having a thickness of about 0.75 to about 25 mm and has elongation at bursting point of about 50 to about 1,200% in the longitudinal direction. The tape can be strongly bonded to the supporting plate but after the tape is pulled from the surface of the supporting plate at an angle of about 35° or less, the substrate is not broken prior to the peel of the tape from the supporting plate, the remains of the pressure-sensitive adhesive are not substantially left on the supporting plate, and the tape can be thereafter peeled from the supporting plate.

(2) An adhesive tape comprising a substrate and layers of a pressure-sensitive adhesive applied to both surfaces of the substrate, wherein the substrate includes a first polymer foam layer and a polymer film layer bonded to the first polymer foam layer or a second polymer foam layer, and has elongation at bursting point of about 50 to about 1,200% in the longitudinal direction, and the tape can be strongly bonded to the supporting plate but after the tape is pulled from the surface of the supporting plate at an angle of about 35° or less, the substrate is not broken prior to the peel of the tape from the supporting plate, and the tape can be thereafter peeled from the supporting plate.

In these adhesive tapes, the polymer foam layers preferably have a thickness of about 0.75 to about 6.25 mm and the substrate preferably has a Young's modulus of not greater than about 16 MPa.

Note that these adhesive tapes are described in detail in Japanese Unexamined Patent Publication (Kokai) No. 9-502213, for example.

The adhesive tape can be used at an arbitrary position and at an arbitrary thickness on the surface of the supporting plate not occupied by the thermally conductive sheet (or the back surface of the image display panel) in consideration of the bonding effect and the handling property.

For example, the adhesive tape can be advantageously used while it is bonded to the peripheral end portion of the supporting plate. The bonding form can be arbitrarily changed. One each adhesive tape may be bonded to the upper side and the lower side of the supporting plate, for example, or two or more adhesive tapes may be juxtaposed, respectively. Otherwise, the adhesive tapes bonded to the upper and lower sides of the supporting plate may be divided into two or more tapes without using one elongated tape.

One adhesive tape may be bonded to each of the right and right sides of the supporting plate, or two or more adhesive tapes may be bonded to each side in juxtaposition. Otherwise, the adhesive tape to be bonded to each side may be divided into two or more tapes without using one elongated tape.

If necessary, the adhesive tape may be bonded in such a manner as to encompass the four sides of the supporting plate, that is, each of the upper, lower, right and left sides.

The bonding position of the adhesive tape is not limited to the peripheral end portion of the supporting plate. If desired, the thermally conductive sheet and the adhesive tape may be alternately bonded to the surface of the supporting plate. For example, a plurality of them may be alternately bonded in a line in the longitudinal direction or in the transverse direction.

When the adhesive tape is bonded to the supporting plate, it is preferred to bond the adhesive tape in such a fashion that its end portion swells out from the end of the supporting plate. The adhesive tape can be pulled and peeled at this end portion and the working factor can be improved.

In the image display apparatus according to the invention, the shapes and the sizes of two or more adhesive tapes used for fixing the image display panel to the supporting plate are preferably the same in one image display apparatus in the ordinary case because the handling property and productivity can be improved. If necessary, however, the adhesive tapes having different shapes or sizes may be used in an arbitrary combination in one image display apparatus.

The adhesive is generally belt-like, and its width and length can be changed over a broad range. Generally, the width is from about 5 to 30 mm. The thickness of the adhesive tape is generally within the range of 0.5 to 3.0 mm.

In the image display apparatus of the invention using the adhesive tape for fixing the image display panel to the supporting plate, the image display panel can be easily separated from the supporting plate. In other words, after the adhesive tape for fixing is stretched and pulled by hand, the panel can be removed quickly and easily without using a specific jig. In the case of the existing adhesive tape, the panel and the supporting plate are peeled from each other by a strong force under the high temperature state, or a wedge-like jig is punched between the panel and the supporting plate and are then left standing for a long time. In other words, large and specific apparatuses are necessary and moreover, a long time is necessary. In view of these facts, this invention provides an extremely remarkable effect. In the invention, it is not necessary to use a panel peeling jig, or the like. Therefore, accidental breakage of the glass substrate constituting the panel does not occur, either.

In the image display apparatus according to the invention, the construction can be simplified, the production time and cost can be reduced, and decomposition for repair and recycling becomes easy. Further, the amounts of wastes can be reduced. As a matter of fact, if the thermally conductive sheet and the adhesive tape are in advance bonded to the supporting plate in the invention, the fixing operation can be easily completed by only pressure-bonding the supporting plate to the image display panel. In the screw fixing method according to the prior art, construction becomes complicated because metals for screw fitting must be fitted to the supporting plate, and the number of components unavoidably increases. The invention can solve such problems.

### EXAMPLES

Next, examples of the invention will be explained. Needless to say, the invention is not particularly limited to these examples.

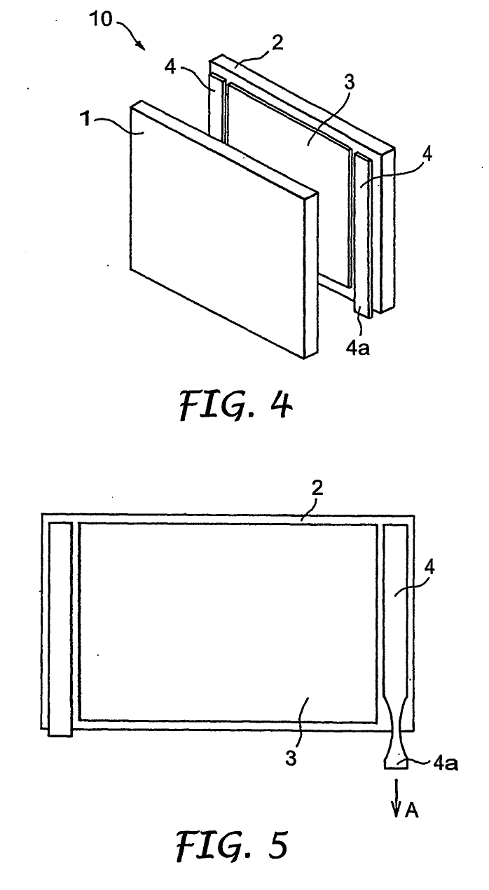

FIG. 4 is an exploded perspective view that shows a preferred example of a plasma display apparatus according to the invention. The plasma display apparatus 10 comprises a PDP 1, an aluminum supporting plate 2 as a supporting plate and a rectangular, thermally conductive sheet 3 sandwiched between the former two members. The PDP 1 is an 82 cm (32 in.)—PDP that has an outer dimension of 80 cm (width)×45 cm (height) and 65 cm (depth). An alumina-dispersion acryl resin film (thickness: 1.0 mm, trade name “9891FR”, product of Sumitomo 3M Ltd.) having slight adhesiveness is cut into a width of 75 cm and a height of 43 cm and is used as the thermally conductive sheet 3. Referring to FIG. 4, one belt-like double-face adhesive tape 4 is shown bonded to each side of the thermally conductive sheet 3, however, two belt-like double-face adhesive tapes 4 are bonded in this example to each side of the thermally conductive sheet 3 as shown in FIG. 7. The double-face adhesive tape 4 used herein is an acryl foam type stretch release double-face tape that can be peeled by pulling and has a width of 10 mm and a length of 47 cm. More concretely, this double-face adhesive tape is prepared as follows. A primer (“N-200” of Sumitomo 3M Ltd.) is applied to both surfaces of an acryl foam tape “Y-4630F” of Sumitomo 3M Ltd., and a linear low density polyethylene (thickness of 50 μm) subjected on its both surfaces to corona treatment is laminated on both surfaces of the foam tape to obtain a substrate. An adhesive transfer tape (“9471LE”, product of 3M Ltd.) is thermally laminated to both surfaces of the substrate. An end portion 4a of the adhesive tape 4 is protruded from the end of the frame 2.

After the PDP 1 is fixed to the frame 2 by use of the adhesive tape 4, projection of color images is continuously conducted for 5 hours in the PDP 1. Since the PDP 1 is used for a long time, the temperature rises. However, because the thermally conductive sheet 3 having a large area is brought into close contact between the PDP 1 and the frame 2, heat generated from the PDP 1 can be effectively dissipated through the thermally conductive sheet 3.

Next, projection of the color images is stopped and the temperature of the PDP 1 is lowered down to the room temperature. Then, the adhesive tape 4 on the right side is pulled at its end portion 4a in a direction of an arrow A (in the longitudinal direction of the adhesive tape) as shown in FIG. 5. A part of the adhesive tape 4 is stretched, and the adhesive tape itself can be peeled without imparting strong force and without leaving the remains of the adhesive. The adhesive tape on the left side can be easily peeled by the same method, too. Since the thermally conductive sheet 3 has the removing property, the PDP 1 can be easily separated from the frame 2.

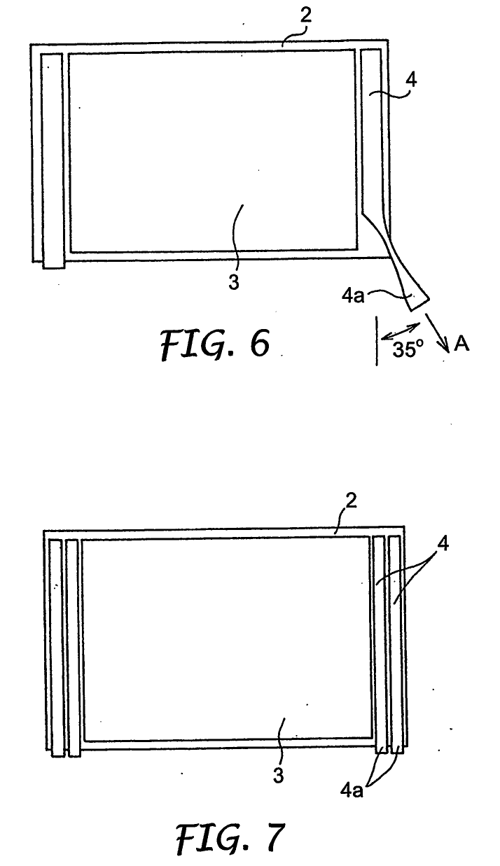

Next, the same separating operation as described above is repeated with the exception that the pulling angle of the arrow A is changed from 0 degree to about 35 degrees as shown in FIG. 6. The adhesive tape 4 can be pulled out by smaller force than in the method shown in FIG. 5. The inventors have found that the double-face adhesive tape used in this example provides in most cases a higher working factor in the tape removing operation when it is pulled in its longitudinal direction. Generally, the inclination angle of pulling is preferably 35 degrees or less and more preferably within the range of about 10 to 30 degrees.

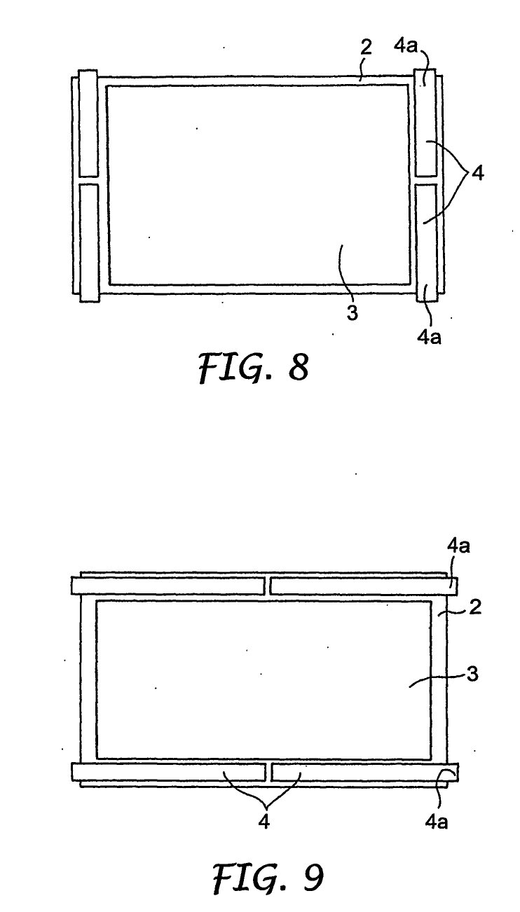

FIGS. 7 to 9 respectively show preferred examples of the fixing method of the PDP in the plasma display apparatus according to the invention. When the adhesive tape 4 fails to secure sufficient bonding strength by the method shown in FIG. 4, for example, two each adhesives may be bonded to both right and left sides of the frame as shown in FIG. 7. The end portion 4a of each adhesive tape 4 preferably protrudes from the end of the frame 2. Alternatively, one each adhesive tape 4 having a considerably large width may be bonded to each side of the frame 2. If the adhesive tape 4 is too long in this case, the tape pulling operation needs a long time. Therefore, one adhesive tape 4 is preferably cut at its intermediate position as shown in the drawing. Furthermore, as shown in FIG. 9, two each adhesive tapes 4 may be bonded to the upper and lower edge portions of the frame 2.

As explained above in detail, the invention can provide an improved panel fixing method that makes it possible to use an adhesive tape having sufficient bonding strength for holding a panel and capable of being easily peeled for removing the panel when a flat display panel (image display panel) is fitted to a supporting plate such as a frame in a plasma display apparatus and other image display apparatuses, and can satisfy both the advantage of the use of conventional adhesive tapes and the advantage of the use of fixing screws.

The invention can also provide an image display apparatus that is simple in construction, makes it easy to conduct repairing of components, disposal, recycling, etc, eliminates remains of adhesives and moreover can be produced at a low cost of production.

The invention can further provides a plasma display apparatus that makes it easy to fix a panel to a frame and to remove them from each other.

1-7. (canceled)

8. An image display apparatus comprising an image display panel and a supporting plate to which a back surface of said image display panel is removably fitted, wherein a thermally conductive sheet is sandwiched between said image display panel and said supporting plate, and at least one adhesive tape having sufficient bonding strength for holding said panel during use of said image display apparatus and capable of being peeled from said plate when pulled at an end portion thereof is bonded to a surface of said supporting plate not occupied by said thermally conductive sheet, optionally wherein said image display panel is a plasma display panel.

9. An image display apparatus according to claim 8, wherein said supporting plate comprises a heat-dissipating material.

10. An image display apparatus according to claim 9, wherein said heat-dissipating material is aluminum or its alloy.

11. An image display apparatus according to claim 8, wherein said thermally conductive sheet comprises a removable sheet material.

12. An image display apparatus according to claim 9, wherein said thermally conductive sheet comprises a removable sheet material.

13. An image display apparatus according to claim 8, wherein said adhesive tape and said thermally conductive sheet are alternately bonded to a surface of said supporting plate.

14. An image display apparatus according to claim 9, wherein said adhesive tape and said thermally conductive sheet are alternately bonded to a surface of said supporting plate.

15. An image display apparatus according to claim 10, wherein said adhesive tape and said thermally conductive sheet are alternately bonded to a surface of said supporting plate.

16. An image display apparatus according to claim 11, wherein said adhesive tape and said thermally conductive sheet are alternately bonded to a surface of said supporting plate.

17. An image display apparatus according to claim 8, wherein said adhesive tape is applied to a peripheral end portion of said supporting plate.

18. An image display apparatus according to claim 9, wherein said adhesive tape is applied to a peripheral end portion of said supporting plate.

19. An image display apparatus according to claim 10, wherein said adhesive tape is applied to a peripheral end portion of said supporting plate.

20. An image display apparatus according to claim 11, wherein said adhesive tape is applied to a peripheral end portion of said supporting plate.

21. An image display apparatus according to claim 12, wherein said adhesive tape is applied to a peripheral end portion of said supporting plate.

22. An image display apparatus according to claim 13, wherein said adhesive tape is applied to a peripheral end portion of said supporting plate.

23. An image display apparatus according to claim 14, wherein said adhesive tape is applied to a peripheral end portion of said supporting plate.

24. An image display apparatus according to claim 15, wherein said adhesive tape is applied to a peripheral end portion of said supporting plate.

25. An image display apparatus according to claim 16, wherein said adhesive tape is applied to a peripheral end portion of said supporting plate.
